(19) United States
(12) Patent Application Publication
(10) Pub. No.: US 2014/0347899 A1
(43) Pub. Date: Nov. 27, 2014

(54) CONTROL METHODS FOR POWER CONVERTERS

(71) Applicant: GE Energy Power Conversion Technology Ltd, Warwickshire (GB)

(72) Inventors: Dominic David BANHAMHALL, Warwickshire (GB); Martin Samuel BUTCHER, Warwickshire (GB)

(73) Assignee: GE Energy Power Conversion Technology Ltd, Warwickshire (GB)

(21) Appl. No.: 14/283,710

(22) Filed: May 21, 2014

(30) Foreign Application Priority Data
May 21, 2013 (EP) 13168560.4

(51) Int. Cl. H02M 1/15

(52) U.S. Cl. CPC H02M 1/15
USPC 363/39

(57) ABSTRACT

A method of operating a power converter arrangement, the power converter arrangement includes a dc link and a dc load/source, an active rectifier/inverter having dc terminals connected to the dc link and is adapted to provide a variable dc link voltage between a maximum and a minimum limits, an interleaved buck converter having a plurality of converter circuits connected between the dc link and the dc load/source, wherein each converter circuit includes a first switch, a second switch, and a reactor, the method including determining one or more null values of dc link voltage with reference to the voltage across the dc load/source, and if a null value of dc link voltage is between the maximum and the minimum limits, controlling the active rectifier/inverter to provide a dc link voltage that is substantially the same as the null value of dc link voltage.

### TECHNICAL FIELD

The present invention relates to control methods for power converters, and in particular to control methods that minimise current ripple.

### BACKGROUND ART

FIG. 1 shows an N-phase interleaved bi-directional buck converter (or step-down converter) topology. Such a converter 1 consists of N converter circuits connected in parallel between a dc link 2 and a dc load/source 4. Each converter circuit has a synchronous topology with a first switch 6₁, 6₂ . . . 6_{N}, a second switch 8₁, 8₂ . . . 8_{N} and a reactor (or inductor) 10₁, 10₂ . . . 10_{N}. In other words, a first converter circuit (or ‘phase’) of the buck converter 1 includes a first switch 6₁, a second switch 8₁ and a reactor 10₁; a second converter circuit includes a first switch 6₂, a second switch 8₂ and a reactor 10₂; and so on for each converter circuit.

A capacitor 12 is connected across the dc link 2.

It will be readily appreciated that because the buck converter is bi-directional, power can flow from the dc link 2 to the dc load/source 4 and power can flow from the dc load/source 4 to the dc link 2 depending on operational requirements.

The switching strategies of the individual converter circuits are interleaved. In other words, the converter circuits operate with the same duty ratio but the start points of their respective switching periods are time displaced by:

$${t}_{start , n} = T \cdot \frac{n - 1}{N} \qquad ( EQ 1 )$$

where: n is the respective converter circuit (i.e., n=1, 2 . . . N), t_{start.n} is the time displacement for the respective converter circuit, and T is the switching period.

The change in the current through each reactor (the so-called circuit current) during the ‘on’ period of the first switches 6₁, 6₂ . . . 6_{N} is given by:

$${V}_{1} - {V}_{2} = L \cdot \frac{Δ {i}_{n}}{D \cdot T} \qquad ( EQ 2 )$$

where: V₁ is the dc link voltage (i.e., the voltage across the dc link 2), V₂ is the voltage across the dc load/source 4, L is the reactor inductance, iₙ is the circuit current for the respective converter circuit, and D is the duty ratio.

Likewise, the change in circuit current iₙ during the ‘off’ period of the first switches 6₁, 6₂ . . . 6_{N} is given by:

$$- {V}_{2} = L \cdot \frac{Δ {i}_{n}}{( 1 - D ) \cdot T} \qquad ( EQ 3 )$$

In continuous operation, the increase in circuit current iₙ during the ‘on’ period must match the decrease in circuit current during the ‘off’ period so that the circuit current never falls to zero. Hence:

(V₁−V₂)·D·T=V₂·(1−D)·T (EQ4)

V₁·D=V₂ (EQ5)

The rate of change of circuit current iₙ for each converter circuit during an ‘on’ period of the first switches 6₁, 6₂ . . . 6_{N} is given by:

$$\begin{matrix}\frac{d {i}_{n}}{d t} = \frac{{V}_{1} - {V}_{2}}{L} \\ = \frac{{V}_{1} \cdot ( 1 - D )}{L}\end{matrix} \qquad ( EQ 6 )$$

Likewise, the rate of change of circuit current iₙ for each converter circuit during an ‘off’ period of the first switches 6₁, 6₂ . . . 6_{N} is given by

$$\begin{matrix}\frac{d {i}_{n}}{d t} = \frac{- {V}_{2}}{L} \\ = \frac{- D \cdot {V}_{1}}{L}\end{matrix} \qquad ( EQ 7 )$$

For an N-phase interleaved bi-directional buck converter as shown in FIG. 1 then the total rate of change of converter current I is given by:

$$\frac{d I}{d t} = {\sum }_{1}^{N} \frac{d {i}_{n}}{d t} \qquad ( EQ 8 )$$

In the case where the duty ratio is low, e.g., where D≦1/N, given the circuit interleaving, there can only be a maximum of one converter circuit at any particular time that is ‘on’ (or charging) and the remaining converter circuits must be ‘off’ (or discharging).

In this situation the total rate of change of converter current I is given by:

$$\frac{d I}{d t} = \frac{{V}_{1} \cdot ( 1 - D )}{L} - ( N - 1 ) \cdot \frac{D \cdot {V}_{1}}{L} \qquad ( EQ 9 )$$

which simplifies to:

$$\frac{d I}{d t} = \frac{{V}_{1}}{L} - \frac{N \cdot D \cdot {V}_{1}}{L} \qquad ( EQ 10 )$$

Therefore, the rate of change of converter current I will be zero, provided that:

1=N·D (EQ11)

A higher duty ratio can be defined by:

$$\frac{a - 1}{N} < D \leq \frac{a}{N} \qquad ( EQ 12 )$$

where a is a positive integer less than N.

In this situation, a converter circuits can be ‘on’ (or charging) at any particular time and (N−a) converter circuits can be ‘off’ (or discharging). The total rate of change of converter current I is given by:

$$\frac{d I}{d t} = a \cdot \frac{{V}_{1} \cdot ( 1 - D )}{L} - ( N - a ) \cdot \frac{D \cdot {V}_{1}}{L} \qquad ( EQ 13 )$$

which simplifies to:

$$\frac{d I}{d t} = \frac{a \cdot {V}_{1}}{L} - \frac{N \cdot D \cdot {V}_{1}}{L} \qquad ( EQ 14 )$$

Therefore, the rate of change of converter current I will be zero, provided that:

a=N·D (EQ15)

### SUMMARY OF THE INVENTION

The present invention provides a method of operating a power converter arrangement comprising: a dc link; a dc load/source; an active rectifier/inverter having dc terminals connected to the dc link and adapted to provide a variable dc link voltage (V₁) between maximum and minimum limits (V_{1,max}, V_{1,min}); and an interleaved buck (or step-down) converter having N converter circuits connected between the dc link and the dc load/source, each converter circuit including a first switch, a second switch and a reactor; the method comprising the steps of: determining one or more null values of dc link voltage V_{1,null} with reference to the voltage V₂ across the dc load/source according to the equation:

$${V}_{1 , null} = {V}_{2} \cdot \frac{N}{a} \qquad ( EQ 16 )$$

where: N is a positive integer greater than or equal to 2, and a is a positive integer less than N; and if a null value of dc link voltage is between the maximum and minimum limits of the dc link voltage, controlling the active rectifier/inverter to provide a dc link voltage that is substantially the same as the null value of dc link voltage.

If the active rectifier/inverter is controlled to provide a dc link voltage that is substantially the same as a null value of dc link voltage then there will be substantially no ripple on the converter current, i.e., the current experienced by the dc load/source will be substantially ripple-free. In a conventional power converter arrangement the active rectifier/inverter is normally controlled to provide a substantially constant dc link voltage. In the present method, the dc link voltage can be varied deliberately (e.g., by a controller for the active rectifier/inverter) in response to changes in the voltage V₂ across the dc load/source in order to try and minimise current ripple.

If there are two or more null values of dc link voltage between the maximum and minimum limits, the active rectifier/inverter can be controlled to provide a dc link voltage that is substantially the same as any of the null values. However, the highest null value will typically be selected because this lowers the dc link current and reduces losses in the power converter arrangement.

In some situations there may be no null value between the maximum and minimum limits of the dc link voltage. This will depend on the prevailing voltage V₂ across the dc load/source, the particular power converter arrangement (e.g., the number of interleaved buck converter circuits), as well as the operational constraints on the dc link voltage. The prevailing voltage V₂ is likely to depend upon the particular type of dc load/source. If there is no null value between the maximum and minimum limits, the method may further comprise the step of controlling the active rectifier/inverter to provide a dc link voltage that is substantially the same as the maximum or minimum limit of the dc link voltage. Although in this situation current ripple cannot be substantially eliminated, it will be readily appreciated that controlling the active rectifier/inverter to provide a dc link voltage that is substantially the same as the maximum or minimum limit reduces the current ripple as much as possible while still keeping the dc link voltage within its practical and operational constraints. If appropriate, the selection between the maximum or minimum limit can be based on whichever is closer to a null value and hence will provide the least current ripple. In other words, the active rectifier/inverter can be controlled to provide a dc link voltage that is substantially the same as whichever of the maximum and minimum limit will provide the least current ripple for the prevailing voltage V₂. The maximum limit can also be selected in preference to the minimum limit because this lowers the dc link current and reduces losses in the power converter arrangement.

The present invention further provides a power converter arrangement comprising: a dc link; a dc load/source; an active rectifier/inverter having dc terminals connected to the dc link and adapted to provide a variable dc link voltage between maximum and minimum limits; an interleaved buck (or step-down) converter having N converter circuits connected between the dc link and the dc load/source, each converter circuit including a first switch, a second switch and a reactor; and a controller for the active rectifier/inverter adapted to implement the method described above.

The active rectifier/inverter can have any suitable topology and include any suitable power semiconductor switching devices, optionally controlled using a pulse width modulation (PWM) strategy. For example, the active rectifier/inverter can have a two- or three-level topology as appropriate.

### DRAWINGS

FIG. 1 shows an N-phase interleaved bi-directional buck converter;

FIG. 2 shows a power converter arrangement according to the present invention; and

FIGS. 3 and 4 show simulated results for the power converter arrangement of FIG. 2.

### DETAILED DESCRIPTION

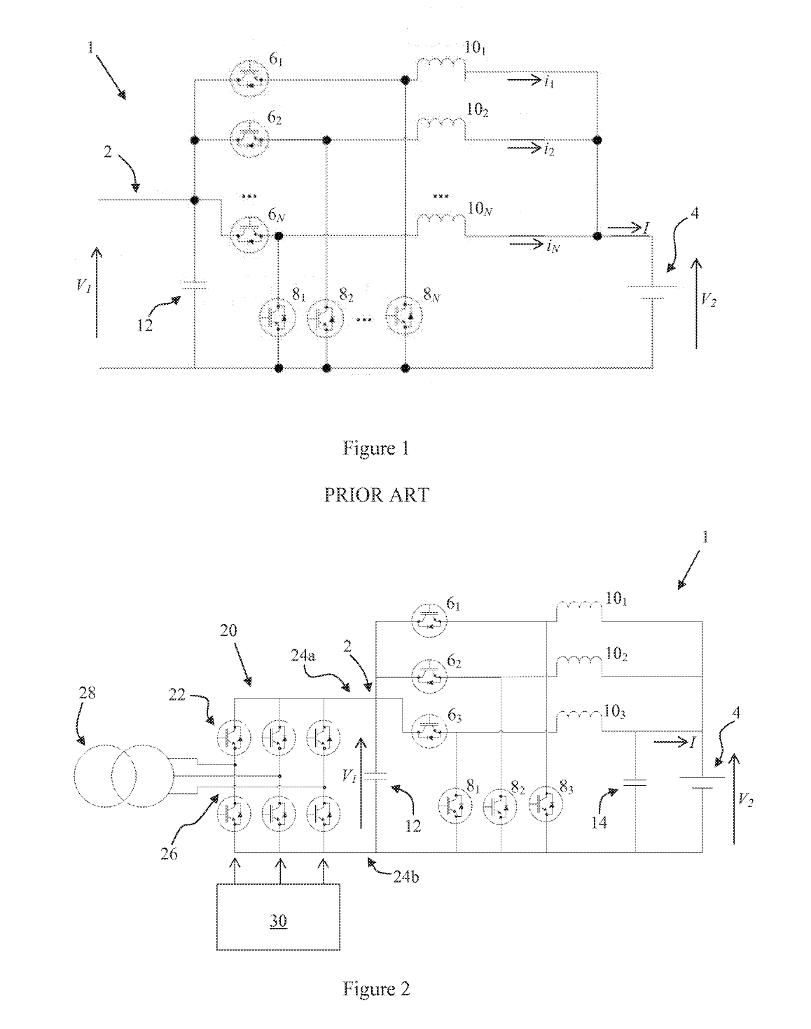

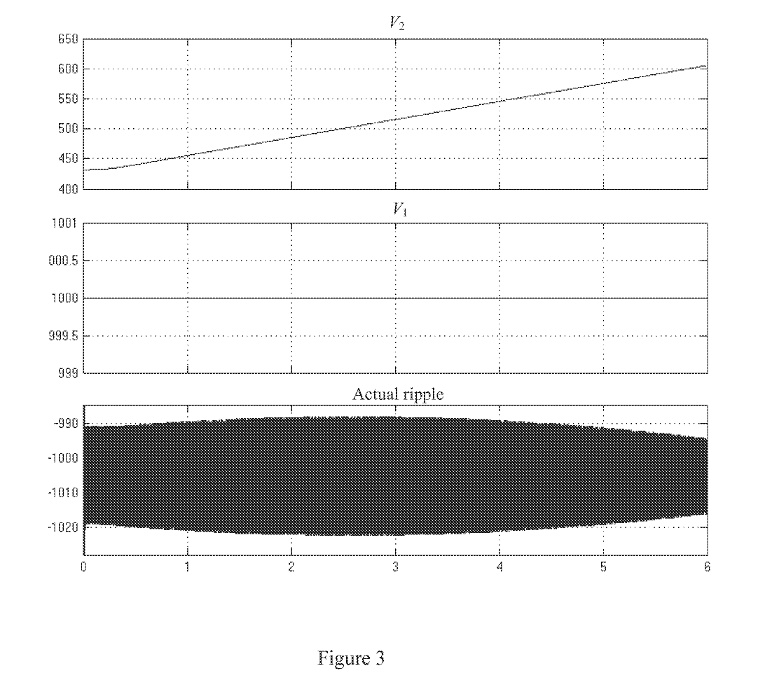

FIG. 2 shows a power converter arrangement according to the present invention where an N-phase interleaved bi-directional buck converter 1 is combined with an AC/DC converter, e.g., an active rectifier/inverter 20. (The buck converter 1 is generally as described above with reference to FIG. 1 and like parts have been given the same reference numeral.) In this case the buck converter 1 is a three-phase converter 1 (i.e., where N=3) and the dc load/source 4 can be a dc energy store such as a battery that can be charged and discharged.

A smoothing capacitor 14 is connected in parallel across the dc load/source 4.

The buck converter 1 operates as a DC/DC converter.

The active rectifier/inverter 20 includes a plurality of switches 22 that are typically controlled to open and close in accordance with a pulse width modulation (PWM) strategy. The active rectifier/inverter 20 is controlled by a controller 30 which provides gate command signals for opening and closing the switches 22. The active rectifier/inverter 20 includes dc terminals 24a, 24b that are connected to the dc link 2 of the buck converter 1 and ac terminals 26 that are connected to an ac network or grid 28. Power can be supplied from the ac network 28 to the dc load/source 4 to charge the dc load/source and in this case the active rectifier/inverter 20 will operate as an active rectifier. Power can be discharged from the dc load/source 4 to the ac network 28 and in this case the active rectifier/inverter 20 will operate as an inverter.

It will be readily appreciated that the active rectifier/inverter 20 can be operated to control the dc link voltage V₁. The applicant has found that the dc link voltage V₁ can be varied deliberately by the controller 30 with reference to the voltage V₂ in order to minimise the ripple on the converter current I.

If equations EQ5 and EQ15 are combined then:

$${V}_{1} = {V}_{2} \cdot \frac{N}{a} \qquad ( EQ 17 )$$

where: N is the total number of interleaved converter circuits, and a is a positive integer less than N.

If the dc link voltage V₁ is controlled to satisfy equation EQ17 then current ripple can be substantially eliminated. This provides significant technical advantages for certain types of dc load/source, e.g., for batteries where current ripple can cause additional heating and an associated lifetime loss.

For the power converter arrangement shown in FIG. 2 (i.e., where N=3) then there will be substantially no ripple on the converter current I if the dc link voltage V₁ is controlled to be 3V₂ (i.e., where a=1) or 3V₂/2 (i.e., where a=2). These values of dc link voltage are referred to herein as null values and can also be considered in terms of null values of the duty cycle D of the buck converter 1. The null values of dc link voltage can be determined (e.g., by the controller 30) for each value of a and with reference to the prevailing voltage V₂ as shown in equation EQ16. The active rectifier/inverter 20 can then be controlled to provide a dc link voltage V₁ that is substantially the same as a null value. The active rectifier/inverter 20 can be controlled in this manner irrespective of whether it is operating as an active rectifier or an inverter. The buck converter 1 is controlled in a conventional manner to supply power from the dc link 2 to the dc load/source 4 or to supply power from the dc load/source to the dc link depending on whether the dc load/source 4 is being charged or discharged.

In a practical power converter arrangement then the dc link voltage V₁ will often be constrained to be within maximum and minimum limits. If there is no null value within the maximum and minimum limits then the ripple current cannot be substantially eliminated, but merely minimised as far as possible by controlling the active rectifier/inverter 20 to provide a dc link voltage V₁ that is substantially the same as one of the maximum and minimum limits, typically the limit that is closest to a null value of the dc link voltage or which minimises losses in the power converter arrangement. It will be understood that this still provides a useful improvement over the conventional power converter arrangement where the dc link voltage V₁ remains substantially constant.

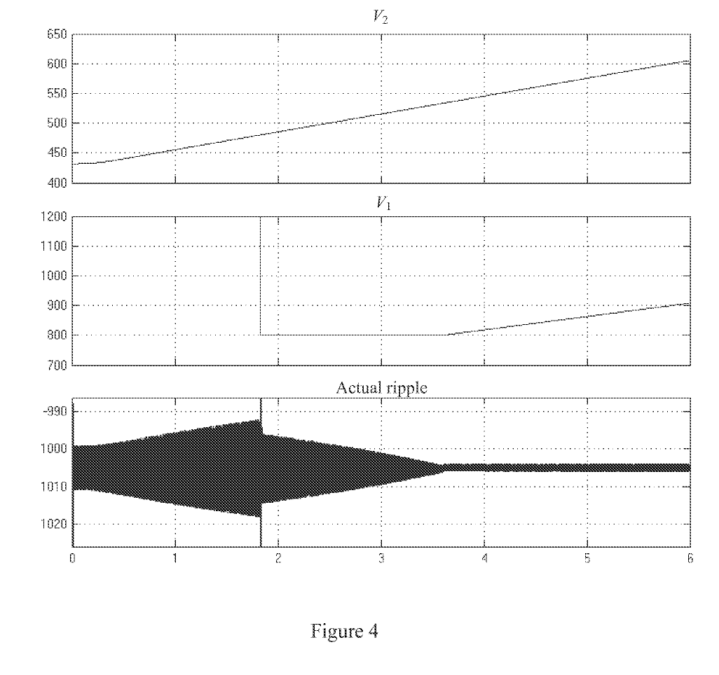

FIGS. 3 and 4 show simulated results for the power converter arrangement of FIG. 2.

In FIG. 3 the power converter arrangement is controlled in a conventional manner such that the dc link voltage V₁ remains substantially constant.

In FIG. 4 the power converter arrangement is controlled according to the method of the present invention such that the dc link voltage V₁ is varied deliberately to minimise current ripple. The simulated parameters include a maximum limit for the dc link voltage Vᵢ so that the rated voltage of the dc link capacitor 12 is not exceeded, and a minimum limit so that the dc link voltage is always higher than the peak of the grid-side ac waveform. More particularly, the dc link voltage V₁ is not allowed to rise above 1200 V (i.e., V_{1,max}=1200 V) or fall below 800 V (i.e., V_{1,min}=800 V).

The upper plot of FIGS. 3 and 4 illustrates a situation where the voltage V₂ across the dc load/source 4 increases at a constant rate from 430 V to 600 V. The lower plot of FIGS. 3 and 4 illustrates current ripple.

In FIG. 3 the middle plot illustrates how the dc link voltage V₁ remains substantially constant at 1 kV.

In FIG. 4 the middle plot illustrates how the dc link dc link voltage V₁ is varied deliberately by the controller 30 for the active rectifier/inverter 20 in order to minimise the current ripple.

Initially, the voltage V₂ is 430 V which gives upper and lower null values for the dc link voltage at 1290 V (i.e., where a=1) and 645 V (i.e., where a=2), respectively. The dc link voltage V₁ cannot be set to either of these null values because they are both outside the maximum and minimum limits. The active rectifier/inverter 20 is therefore controlled to provide a dc link voltage V₁ at the maximum limit of 1200 V.

The dc link voltage V₁ remains constant at the maximum limit of 1200 V and the current ripple gradually increases as the voltage V₂ increases. This is because the dc link voltage V₁ gradually gets further away from the upper null value for the prevailing voltage V₂.

Eventually, as the voltage V₂ increases, it is better for the dc link voltage V₁ to be at the minimum limit of 800 V. The active rectifier/inverter 20 is therefore controlled to switch the dc link voltage Vᵢ from the maximum limit of 1200 V to the minimum level of 800 V.

The active rectifier/inverter 20 is controlled to maintain the dc link voltage V₁ constant at the minimum limit of 800 V and the current ripple gradually decreases as the voltage V₂ increases. This is because the dc link voltage V₁ gradually gets closer to the lower null value for the prevailing voltage V₂.

When the voltage V₂ reaches 533 V the upper and lower null values for the dc link voltage are 1599 V (i.e., where a=1) and 800 V (i.e., where a=2), respectively. The upper null value of 1599 V is still outside the maximum and minimum limits. However, the lower null value of 800 V is at the minimum limit for the dc link voltage V₁. As the voltage V₂ increases further, the lower null value for a=2 will be within the maximum and minimum limits and the active rectifier/inverter 20 is therefore controlled to provide a dc link voltage V₁ that is substantially the same as the lower null value for the prevailing voltage V₂ (i.e., where V₁=3V₂/2). It can be seen that the dc link voltage V₁ will increase in step with the gradually increasing voltage V₂. Ripple on the converter current I is minimised and remains substantially constant.

In general terms, for the power converter arrangement shown in FIG. 2 and the maximum and minimum limits of dc link voltage V₁ mentioned above, current ripple can be substantially eliminated for voltages V₂ between 267 V and 400 V (i.e., where a=1) and between 533 V and 800 V (i.e., where a=2). The dc load/source 4 can be selected to operate substantially at voltages within one (or both) of these ranges. For voltages V₂ outside these ranges then the active rectifier/inverter 20 can only be controlled to set the dc link voltage V₁ to either the maximum or minimum limits so that the current ripple is minimised as far as possible.

The current ripple illustrated in FIG. 4 simulates a power converter arrangement where the reactors 10₁, 10₂ and 10₃ of the buck converter 1 have ideal characteristics. However, the reactors will have stray (or parasitic) resistances that can have an affect on the current ripple that can actually be achieved in practice.

The written description uses examples to disclose the invention, including the best mode, and also to enable any person skilled in the art to practice the invention, including making and using any device or system and performing the incorporated method. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial difference from the literal language of the claims.

What is claimed is:

1. A method of operating a power converter arrangement comprising a dc link, a dc load/source, an active rectifier/inverter comprising dc terminals connected to the dc link and configured to provide a variable dc link voltage V₁ between a maximum and a minimum limits, and an interleaved buck converter comprising N converter circuits connected between the dc link and the dc load/source, wherein each of the N converter circuits comprises a first switch, a second switch, and a reactor, the method comprising:
determining one or more null values of dc link voltage V_{1,null} with reference to the voltage V₂ across the dc load/source according to the equation:
$${V}_{1 , null} = {V}_{2} \cdot \frac{N}{a}$$
where:
N is a positive integer greater than or equal to 2, and
a is a positive integer less than N; and
if a null value of dc link voltage is between the maximum and the minimum limits of the dc link voltage, controlling the active rectifier/inverter to provide a dc link voltage that is substantially the same as the null value of dc link voltage.

2. The method of operating a power converter arrangement according to claim 1, further comprising:
if there are two or more null values of dc link voltage between the maximum and the minimum limits, controlling the active rectifier/inverter to provide a dc link voltage that is substantially the same as the highest null value.

3. The method of operating a power converter arrangement according to claim 2, further comprising:
if no null value of dc link voltage is between the maximum and the minimum limits, controlling the active rectifier/inverter to provide a dc link voltage that is substantially the same as the maximum or the minimum limit of the dc link voltage.

4. The method of operating a power converter arrangement according to claim 1, further comprising:
if no null value of dc link voltage is between the maximum and the minimum limits, controlling the active rectifier/inverter to provide a dc link voltage that is substantially the same as the maximum or the minimum limit of the dc link voltage.

5. A power converter arrangement, comprising:
a dc link;
a dc load/source;
an active rectifier/inverter comprising dc terminals connected to the dc link and configured to provide a variable dc link voltage V₁ between a maximum and a minimum limits;
an interleaved buck converter comprising N converter circuits connected between the dc link and the dc load/source, each of the N converter circuits comprising a first switch, a second switch, and a reactor; and
a controller for the active rectifier/inverter, wherein the controller is configured to:
determine one or more null values of dc link voltage V_{1,null} with reference to the voltage V₂ across the dc load/source according to the equation:
$${V}_{1 , null} = {V}_{2} \cdot \frac{N}{a}$$
where:
N is a positive integer greater than or equal to 2, and
a is a positive integer less than N, and
if a null value of dc link voltage is between the maximum and the minimum limits of the dc link voltage, control the active rectifier/inverter to provide a dc link voltage that is substantially the same as the null value of dc link voltage.

6. The power converter arrangement according to claim 5, wherein if there are two or more null values of dc link voltage between the maximum and the minimum limits, the controller is further configured to control the active rectifier/inverter to provide a dc link voltage that is substantially the same as the highest null value.

7. The power converter arrangement according to claim 6, wherein if no null value of dc link voltage is between the maximum and the minimum limits, the controller is further configured to control the active rectifier/inverter to provide a dc link voltage that is substantially the same as the maximum or the minimum limit of the dc link voltage.

8. The power converter arrangement according to claim 5, wherein if no null value of dc link voltage is between the maximum and the minimum limits, the controller is further configured to control the active rectifier/inverter to provide a dc link voltage that is substantially the same as the maximum or the minimum limit of the dc link voltage.
